(19) United States
(12) Patent Application Publication
(10) Pub. No.: US 2020/0175706 A1
(43) Pub. Date: Jun. 4, 2020

(54) THREE-DIMENSIONAL POSITION DETECTING DEVICE, THREE-DIMENSIONAL POSITION DETECTING SYSTEM AND METHOD FOR DETECTING THREE-DIMENSIONAL POSITIONS

(71) Applicants: Hitoshi NAMIKI, Kanagawa (JP); Toshishige FUJII, Kanagawa (JP); Takeshi UEDA, Singapore (SG)

(72) Inventors: Hitoshi NAMIKI, Kanagawa (JP); Toshishige FUJII, Kanagawa (JP); Takeshi UEDA, Singapore (SG)

(73) Assignee: Ricoh Company, Ltd., Tokyo (JP)

(21) Appl. No.: 16/697,669

(22) Filed: Nov. 27, 2019

(30) Foreign Application Priority Data
Nov. 29, 2018 (JP) 2018-224199

(51) Int. Cl. G06T 7/593; G06T 7/70; H04N 13/204; G01S 17/89; G01S 7/481

(52) U.S. Cl. CPC G06T 7/593; G06T 7/70; G06T 2207/10028; G01S 17/89; G01S 7/4817; H04N 13/204

(57) ABSTRACT

A three-dimensional position detecting device includes a rotational mechanism configured to rotate about a predetermined rotation axis, and includes a LIDAR unit disposed on the rotation axis to scan in response to each rotation angle at which the rotational mechanism rotate to detect at least one first three-dimensional position of an object. The three-dimensional position detecting device includes an imaging unit disposed to be away from the rotation axis in a direction perpendicular to the rotation axis, the imaging unit being configured to capture multiple images of the object based on rotation of the imaging unit through the rotational mechanism. The three-dimensional position detecting device includes a processor configured to detect a second three-dimensional position of the object based on the captured multiple images with respect to respective rotation angles at which the rotational mechanism rotates.

### CROSS-REFERENCE TO RELATED APPLICATION

The present application claims priority under 35 U.S.C. § 119 to Japanese Patent Application No. 2018-224199, filed Nov. 29, 2018, the contents of which are incorporated herein by reference in their entirety.

### BACKGROUND OF THE INVENTION

### 1. Field of the Invention

The present disclosure relates to a three-dimensional position detecting device, a three-dimensional position detecting system, and a method for detecting three-dimensional positions.

### 2. Description of the Related Art

A time-of-flight (TOA) technique has been known to measure a distance to an object based on a time difference between a time point at which an emitting element or the like irradiates the object with light and a time point at which light reflected by the object is received.

In relation to the TOF technique, a LIDAR (Light Detection and Ranging) device is widely used in aircrafts, railways, in-vehicle systems, or the like. The scanning LIDAR device detects the presence or absence of an object in a predetermined area, and obtains a three dimensional position of the object. In this case, laser light emitted by a laser source is scanned with a rotational mirror, and then light reflected or scattered by an object is detected via the rotational mirror by a light receiving element.

As the scanning LIDAR device, a device is disclosed to add an offset signal indicating an offset amount that temporally varies to a voltage signal (received light signal) that is responsive to an output current flowing from a light receiving element. Thereby, accurate detection of information on an object that a three-dimensional position detecting device or the like is directed to is improved (e.g., Japanese Unexamined Patent Application Publication No. 2017-161377 which is hereafter referred to as Patent Document 1).

### SUMMARY OF THE INVENTION

The present disclosure has an object of detecting an accurate three-dimensional position of a given object.

In one aspect according to the present disclosure, a three-dimensional position detecting device includes: a rotational mechanism configured to rotate about a predetermined rotation axis; a LIDAR (Light Detection And Ranging) unit disposed on the rotation axis, the LIDAR unit being configured to scan in accordance with each rotation angle at which the rotational mechanism rotates to detect at least one first three-dimensional position of an object; an imaging unit disposed to be away from the rotation axis in a direction perpendicular to the rotation axis, the imaging unit being configured to capture multiple images of the object based on rotation of the imaging unit through the rotational mechanism; a memory; and a processor electrically coupled to the memory. The processor is configured to: detect a second three-dimensional position of the object based on the captured multiple images with respect to respective rotation angles at which the rotational mechanism rotates; and obtain a three-dimensional position of the object based on a comparison of the first three-dimensional position and the second three-dimensional position; and output the three-dimensional position.

### BRIEF DESCRIPTION OF THE DRAWINGS

FIG. 1A is a perspective view of an example of a three-dimensional position detecting device according to a first embodiment;

FIG. 1B is a top view of an example of the three-dimensional position detecting device according to the first embodiment;

FIG. 1C is a side view of an example of the three-dimensional position detecting device according to the first embodiment;

FIG. 2 is a block diagram for explaining an example of a configuration of a LIDAR unit according to the first embodiment;

FIG. 3 is a block diagram for explaining an example of a hardware configuration of a processor according to the first embodiment;

FIG. 4 is a block diagram for explaining an example of a functional configuration of the processor according to the first embodiment;

FIG. 5 is a diagram for explaining an example of an image captured by a 360-degree camera according to the first embodiment;

FIG. 6 is a diagram for explaining an example of a process of converting a position of the 360-degree camera with respect to the LIDAR unit;

FIG. 7 is a diagram for explaining an example of a process of mapping between coordinate spaces of first three-dimensional position information and second three-dimensional position information;

FIG. 8 is a diagram for explaining an example of processing performed by a three-dimensional position comparator;

FIG. 9 is a flowchart illustrating an example of an operation of the three-dimensional position detecting device according to the first embodiment;

FIG. 10 is a diagram illustrating an example of a detected result obtained by the three-dimensional position detecting device according to the first embodiment;

FIG. 11 is a diagram for explaining an example of a detection method by a three-dimensional position detecting system according to a second embodiment;

FIG. 12 is a block diagram for explaining an example of a functional configuration of the three-dimensional position detecting system according to the second embodiment; and

FIG. 13 is a flowchart illustrating an example of an operation of the three-dimensional position detecting system according to the second embodiment.

### DETAILED DESCRIPTION OF THE EMBODIMENTS

One or more embodiments will be described with reference to the drawings. In each figure, same reference numerals are used to denote the same elements; accordingly, for those elements, explanation may be omitted.

### First Embodiment

### Configuration of Three-Dimensional Position Detecting Device

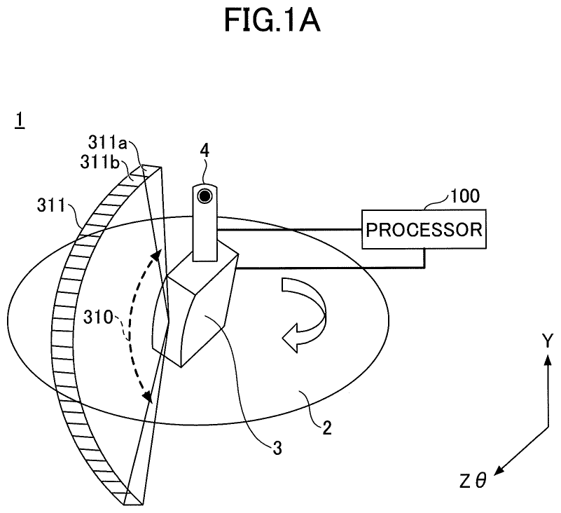

FIGS. 1A through 1C are diagrams illustrating an example of a configuration of a three-dimensional position detecting device according to the present embodiment. FIG. 1A is a perspective view of the three-dimensional position detecting device. FIG. 1B is a top view of the three-dimensional position detecting device. FIG. 1C is a side view of the three-dimensional position detecting device.

As illustrated in FIGS. 1A through 1C, the three-dimensional position detecting device 1 includes a rotational stage 2, and a LIDAR (Light Detection And Ranging) unit 3 disposed on the rotational stage 2. The three-dimensional position detecting device 1 includes a 360-degree camera 4 disposed on a housing of the LIDAR unit 3.

The rotational stage 2 is an example of a rotational mechanism. The rotational stage 2 can cause each of the LIDAR unit 3 and the 360-degree camera 4 mounted on the rotational stage 2 to rotate about an A-axis (an example of a predetermined rotation axis).

The LIDAR unit 3 is fixed on the A-axis of the rotational stage 2. The LIDAR unit 3 can detect a three-dimensional position of an object existing in each direction (which may be hereafter referred to a detection direction) in which the LIDAR unit 3 performs detection, while changing such a detection direction about the A-axis, in accordance with rotation of the rotational stage 2.

The LIDAR unit 3 is a scanning laser that measures a distance from the LIDAR unit 3 to an object in a given detection direction. The LIDAR unit 3 irradiates an object with scanned light, and can measure a distance from the LIDAR unit 3 to the object based on time of flight that is round trip time taken by the scanned light, the scanned light being emitted toward the object to be received as light reflected (scattered) by the object with respect to the scanned light.

The dashed arrow 310 illustrated in FIG. 1A indicates a direction (which may be referred to as a scan direction) of scanning with light, and the numeral 311 indicates scanned light. For example, a distance to an object in a direction of laser light 311a can be measured based on reflected light of laser light 311a with respect to scanned light. Further, a distance to an object in a direction of laser light 311b can be measured based on reflected light of laser light 311b.

Note that the LIDAR unit 3 illustrated in FIG. 1A is a single axis scanning LIDAR system, which scans with laser light with respect to a direction parallel to the A-axis (Y direction) with widening of the projected light in a direction perpendicular to the A-axis. In such a manner, the laser light is emitted toward an object within a scan range defined by two directions that are perpendicular to each other.

However, the LIDAR unit 3 is not limited to the example described above, and may include a two-axis scanning LIDAR system that scans with respect to two directions that are mutually perpendicular. When the LIDAR unit 3 is taken above as the two-axis scanning LIDAR system, in the direction perpendicular to the A-axis, it is also possible to concentrate laser light with which a given object is irradiated. Thereby, light intensity of reflected light can be increased, and thus accuracy in measurement of distances can be improved. Such a configuration of scanning light in two directions that are mutually perpendicular is used as an example of a “light scanning unit configured to scan with light with respect to two axial directions that are mutually perpendicular.”

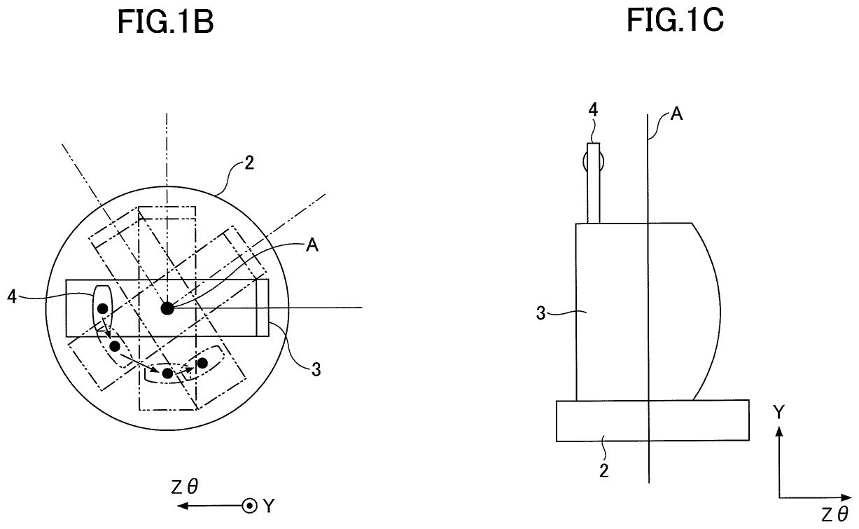

A configuration of the LIDAR unit 3 will be described below in detail with reference to FIG. 2.

The 360-degree camera 4 is an example of an “imaging unit”. The 360-degree camera 4 is a single camera that can capture a 360-degree image photographed from all directions with a single shooting. As illustrated in FIG. 1C, the 360-degree camera 4 is disposed on the housing of the LIDAR unit 3. The 360-degree camera 4 can capture an image of a given object, while changing a direction (angle) in which the 360-degree camera 4 images the object, about the A-axis in accordance with rotation of the rotational stage 2.

In a direction perpendicular to the A-axis, the 360-degree camera 4 is disposed in a location apart from the A-axis. In such a manner, the 360-degree camera 4 can change both of an angle and a location in accordance with the rotation of the rotational stage 2. Thereby, the 360-degree camera 4 can capture an image with a disparity in accordance with the rotation of the rotational stage 2.

Note that as long as the 360-degree camera 4 can capture a 360-degree image, an optical axis of an imaging lens provided in the 360-degree camera 4 may not be directed to be aligned with a direction in which the LIDAR unit 3 performs detection. The 360-degree camera 4 may be disposed toward any direction. In FIGS. 1A through 1C, for illustrative purpose, an optic axial direction of the imaging lens is aligned with the direction in which the LIDAR unit 3 performs detection.

In FIGS. 1A through 1C, the Y direction indicates a direction parallel to the A-axis. A Zθ direction indicates each of two directions that are a direction in which the LIDAR unit 3 performs detection and a direction in which the 360-degree camera 4 performs imaging, where the two directions change about the A-axis in accordance with the rotation of the rotational stage 2. In the subsequent figures, a Y direction and a Zθ direction are identical to directions described above.

### Configuration of LIDAR Unit

Hereafter, the configuration of the LIDAR unit 3 provided in the three-dimensional position detecting device 1 will be described. FIG. 2 is a block diagram for explaining an example of the configuration of the LIDAR unit 3.

As illustrated in FIG. 2, the LIDAR unit 3 includes a light emitting system 31, a receiving optics system 33, a detecting system 34, a time measuring unit 345, a synchronization system 35, a measuring controller 346, and a three-dimensional position detector 347.

The light emitting system 31 includes an LD (Laser Diode) 21 as a light source, an LD drive unit 312, and an emitting optics system 32. The LD 21 is a semiconductor element that outputs pulsed laser light in response to an LD drive current flowing from the LD drive unit 312. As an example, the LD includes an edge emitting laser, or the like.

The LD drive unit 312 is a circuit from which a pulsed drive current flows in response to an LD drive signal from the measuring controller 346. The LD drive unit 312 includes a capacitor from which a drive current flows, a transistor for switching conduction or non-conduction between the capacitor and the LD 21, a power supply, and the like.

The emitting optics system 32 is an optical system for controlling laser light outputted from the LD 21. The emitting optics system 32 includes a coupling lens for collimating laser light, a rotational mirror as a deflector for changing a direction in which laser light propagates, and the like. Pulsed laser light outputted from the emitting optics system 32 is used as scanned light.

The receiving optics system 33 is an optical system for receiving light reflected by an object with respect to scanned light that is emitted in a scan range. The receiving optics system 33 includes a condenser, a collimating lens, and the like.

The detecting system 34 is an electric circuit that performs photoelectric conversion of reflected light and that generates an electric signal for calculating time of flight taken by light. The detecting system 34 includes a time measuring PD (Photodiode) 342, and a PD output detector 343.

The time measuring PD 342 is a photodiode from which a current (detected current) flows in accordance with an amount of reflected light. The PD output detector 343 includes an I-to-V converting circuit that supplies a voltage (detected voltage) in response to a detected current flowing from the time measuring PD 342, and the like.

The synchronization system 35 is an electric circuit, that performs photoelectric conversion of scanned light and that generates a synchronization signal for adjusting a timing of emitting scanned light. The synchronization system 35 includes a synchronization detecting PD 354 and a PD output detector 356. The synchronization detecting PD 354 is a photodiode from which a current flows in response to an amount of scanned light. The PD output detector 356 is a circuit that generates a synchronization signal using a voltage that corresponds to a current flowing from the synchronization detecting PD 354.

The time measuring unit 345 is a circuit that measures time of flight with respect to light based on an electric signal (such as a detected voltage) generated by the detecting system 34 and an LD drive signal generated by the measuring controller 346. For example, the time measuring unit 345 includes a CPU (Central Processing Unit) controlled by a program, a suitable IC (Integrated Circuit), and the like.

The time measuring unit 345 estimates a timing of receiving light by the time measuring PD 342, based on a detected signal (timing at which the PD output detector 356 detects a received signal) from the PD output detector 356. The time measuring unit 345 then measures a round trip time to an object, based on the estimated timing of receiving light and a timing at which an LD drive signal rises. Further, the time measuring unit 345 outputs, to the measuring controller 346, the measured round trip time to the object as a measured result of time.

The measuring controller 346 converts the measured result of time from the time measuring unit 345, into a distance to calculate a round trip distance to an object. The measuring controller 346 further outputs distance data indicative of half of the round trip distance to the three-dimensional position detector 347.

The three-dimensional position detector 347 detects a three-dimensional position at which an object is present, based on multiple pieces of distance data obtained with one or more scans through the measuring controller 346. The three-dimensional position detector 347 further outputs three-dimensional position information to the measuring controller 346. The measuring controller 346 transmits the three-dimensional position information from the three-dimensional position detector 347, to the processor 100. In this description, the three-dimensional position obtained by the LIDAR unit 3 is an example of a “first three-dimensional position”, and is hereafter referred to as the first three-dimensional position.

The measuring controller 346 can receive a measurement-control signal (e.g., a measurement-start signal, a measurement-finish signal, or the like) from the processor 100 to start or finish measuring.

Note that the LIDAR unit 3 can be taken as a system described in Patent Document 1, or the like. Accordingly, the detailed explanation for the LIDAR unit 3 will not be provided.

### Hardware Configuration of Processor

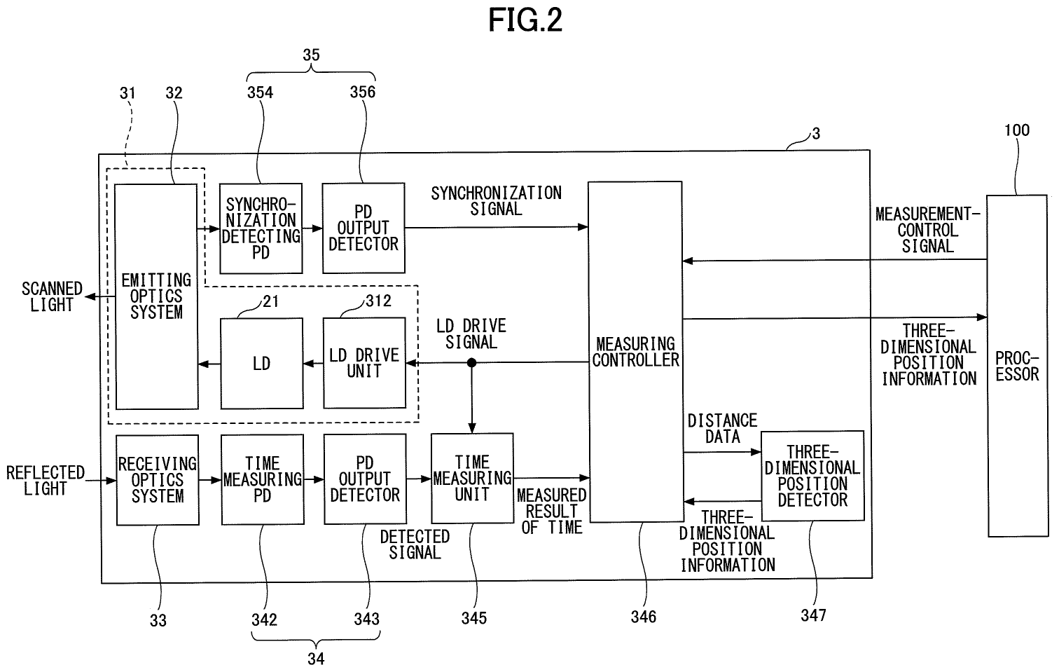

Hereafter, a hardware configuration of the processor 100 provided in the three-dimensional position detecting device 1 will be described. FIG. 3 is a block diagram for explaining an example of a hardware configuration of the processor.

The processor 100 includes a CPU (Central Processing Unit) 101, a ROM (Read Only Memory) 102, a RAM (Random Access Memory) 103, an SSD (Solid State Drive) 104, and an input and output IF (Interface) 105. These components are interconnected via a system bus B.

The CPU 101 is an arithmetic device that allows for control and functions of the entire processor 100. The arithmetic device reads program(s) or data in a storage device such as the ROM 102 or the SSD 104, into the RAM 103 to execute a process. Note that some or all of functions of the CPU 101 may be implemented by hardware such as an ASIC (Application Specific Integrated Circuit), or a FPGA (Field-Programmable Gate Array).

The ROM 102 is a non-volatile semiconductor memory (storage device) that is capable of storing program(s) and data even when the processor 100 is turned off. The ROM 102 stores programs and data for setting BIOS (Basic Input and Output System), OS (Operating System), and a network. The RAM 103 is a volatile semiconductor memory (storage device) that temporarily stores program(s) and data.

The SSD 104 is a non-volatile memory in which a program or various data for executing a process by the processor 100 is stored. Note that the SSD may include an HDD (Hard Disk Drive).

The input and output IF 105 is an interface for connecting to an external device such as a PC (Personal Computer) or a video device.

### Functional Configuration of Processor

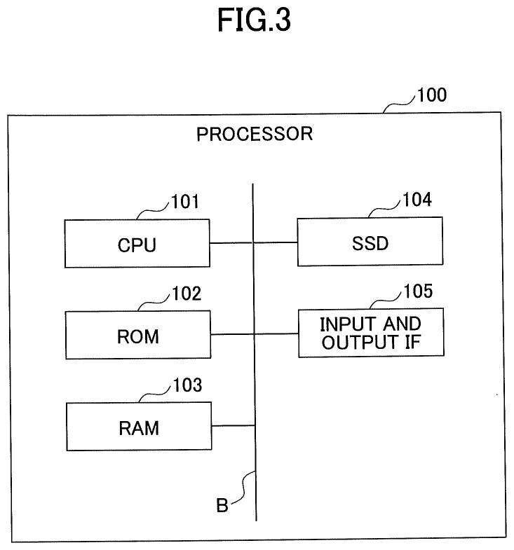

Hereafter, a functional configuration of the processor 100 will be described. FIG. 4 is a block diagram for explaining an example of a functional configuration of the processor.

As illustrated in FIG. 4, the processor 100 includes a rotation controller 111, a LIDAR controller 112, a stereo detector 113, a coordinate-space mapping unit 114, a three-dimensional position comparator 115, and a three-dimensional position output unit 116.

The rotation controller 111 is electrically connected to the rotational stage 2, and controls rotation of the rotational stage 2. The rotation controller 111 can include an electric circuit that outputs a drive voltage in response to a control signal, or the like.

The LIDAR controller 112 is electrically connected to the LIDAR unit 3. The LIDAR controller 112 can output a measurement-control signal to the measuring controller 346 to control the start or finish of measurement.

The stereo detector 113 is electrically connected to the 360-degree camera 4. The stereo detector 113 can receive an image that the 360-degree camera 4 captures with respect to each rotation angle about the A-axis. As described above, there is a disparity between images. In such a manner, the stereo detector 113 can detect a three-dimensional position based on disparities created by stereo matching, and store three-dimensional position information in the RAM 103, or the like.

A three-dimensional position detected by the stereo detector 113 is an example of a “second three-dimensional position”, and is hereinafter referred to as the second three-dimensional position. The stereo detector 113 is an example of an “image detector.”

Note that the stereo matching can be taken as a known technique such as a block matching method or a semi-global matching method; accordingly, the detailed explanation will be omitted for the stereo matching.

Also, instead of the stereo matching, an SFM (Structure From Motion) method in which the shape of a given object is recovered from a plurality of images that are based on images captured by the 360-degree camera 4, may be used to detect a three-dimensional position of the object. The SFM method is also taken as a known technique; accordingly, the detailed explanation for the SFM method will not be provided.

The coordinate-space mapping unit 114 is electrically connected to the LIDAR unit 3. The coordinate-space mapping unit 114 receives first three-dimensional position information from the LIDAR unit 3, and receives second three-dimensional position information from the stereo detector 113. The coordinate-space mapping unit 114 can perform mapping between coordinate spaces of the first three-dimensional position information and the second three-dimensional position information. Further, the coordinate-space mapping unit 114 can store the first three-dimensional position information and second three-dimensional position information that are associated with a given mapped coordinate-space, in the RAM 103, or the like.

The three-dimensional position comparator 115 compares first three-dimensional position information and second three-dimensional position information, which are associated with a given mapped coordinate space. The three-dimensional position comparator 115 then selects three-dimensional position information that is estimated to be accurate, from the first three-dimensional position information. The three-dimensional position comparator 115 outputs the selected three-dimensional position information to the three-dimensional position output unit 116.

The three-dimensional position output unit 116 can output the three-dimensional position information received from the three-dimensional position comparator 115.

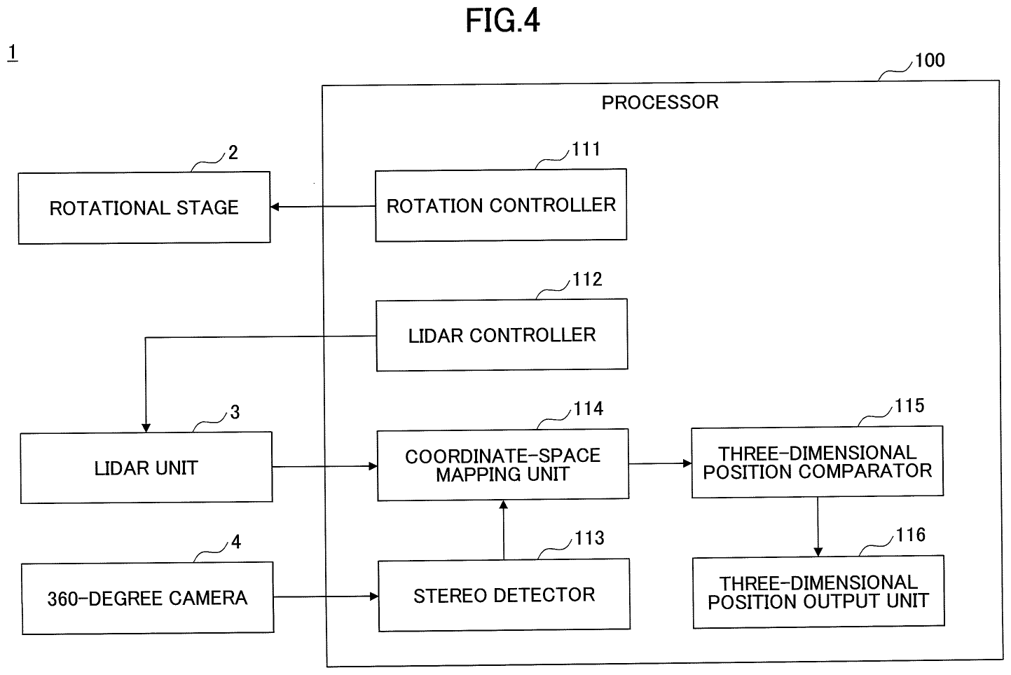

FIG. 5 is a diagram for explaining an example of an image captured by the 360-degree camera according to the present embodiment. In FIG. 5, the rotational stage 2 rotates in a direction indicated by a thick arrow 53. A direction Zθ in which the 360-degree camera 4 performs imaging changes about the A-axis in accordance with rotation of the rotational stage 2. With respect to each predetermined rotation angle at which the rotational stage 2 rotates, an image of an object 51 is captured by the 360-degree camera 4. In FIG. 5, images 52a through 52d are each examples of an image captured by the 360-degree camera 4 that rotates at a given predetermined rotation angle.

As described above, the 360-degree camera 4 is disposed to be away from the A-axis in a direction perpendicular to the A-axis, and rotates in a circle as illustrated in FIG. 5. In this case, the images 52a through 52d each have a disparity created by a given rotation radius and a given rotation angle. The stereo detector 113 can utilize such a disparity to detect a three-dimensional position of the object 51 by stereo matching.

Hereafter, processing by the coordinate-space mapping unit 114 will be described.

In this description, a first three-dimensional position is a three-dimensional position determined by a reference to a location in which the LIDAR unit 3 is disposed. A second three-dimensional position is a three-dimensional position determined by a reference to a location in which the 360-degree camera 4 is disposed. As described above, on the rotational stage 2, the LIDAR unit 3 is disposed on the A-axis, and the 360-degree camera 4 is disposed to be away from the A-axis in a direction perpendicular to the A-axis.

In such a manner, the first three-dimensional position and the second three-dimensional position are respectively determined by different reference locations to belong to different coordinate spaces. For this reason, the coordinate-space mapping unit 114 maps a coordinate space of second three-dimensional position information onto a coordinate space of first three-dimensional position information.

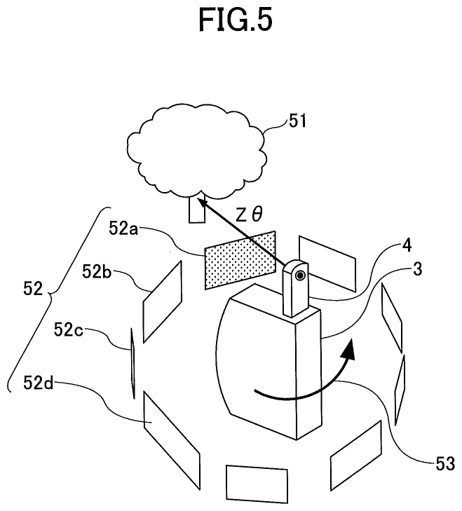

FIG. 6 is a diagram for explaining an example of a process of converting a location of the 360-degree camera with respect to the LIDAR unit. Note that this process is one of processes performed by the coordinate-space mapping unit 114.

In FIG. 6, a distance from the A-axis to the 360-degree camera 4 in a direction perpendicular to the A-axis is set as t. In a Y direction, a distance between an A-axis point of the LIDAR unit 3 and an optical axis of the 360-degree camera 4 is set as h.

Further, when the rotational stage 2 is positioned at the origin for rotation, a direction in which the LIDAR unit 3 performs detection and a direction in which the 360-degree camera 4 performs imaging are each set as Z0. When the rotational stage 2 rotates at a rotation angle of θ, a direction in which the LIDAR unit 3 performs detection and a direction in which the 360-degree camera 4 performs imaging are each set as Zθ.

From these relationships, an optical axis point of the 360-degree camera 4 with respect to the A-axis point of the LIDAR unit 3 can be expressed by Equation (1) below.

$$\begin{matrix}[ Math . 1 ] & \\ ( \begin{matrix}x \\ y \\ z\end{matrix} ) = ( \begin{matrix}t \times cos θ \\ h \\ t \times sin θ\end{matrix} ) & ( 1 )\end{matrix}$$

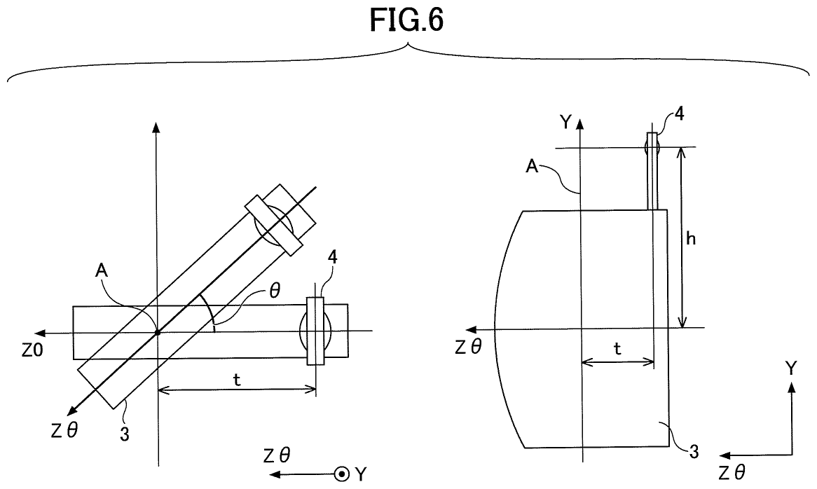

FIG. 7 is a diagram for explaining an example of a process of mapping between coordinate spaces of first three-dimensional position information and second three-dimensional position information. Note that this process is also one of processes performed by the coordinate-space mapping unit 114.

In FIG. 7, when respective coordinates of an image 53a captured by the 360-degree camera 4 indicate u and v, a coordinate space (x, y, z) for a second three-dimensional position with respect to the 360-degree camera 4 can be represented by Equation (2) below.

$$\begin{matrix}[ Math . 2 ] & \\ ( \begin{matrix}x \\ y \\ z\end{matrix} ) = \frac{z}{f} ( \begin{matrix}u - {u}_{0} \\ v - {v}_{0} \\ f\end{matrix} ) & ( 2 )\end{matrix}$$

Where, in Equation (2), u0 and v0 each indicate a central coordinate of a captured image. For example, when the number of pixels of a captured image is 1920×1080 pixels, u0 and v0 are indicated as (u0, v0)=(960, 540). Also, f indicates focal length of the 360-degree camera 4.

From Equations (1) and (2) and a rotation angle θ at which the rotational stage 2 rotates, a coordinate space of second three-dimensional position information is converted using Equation (3) below to be mapped onto a coordinate space of first three-dimensional position information.

$$\begin{matrix}[ Math . 3 ] & \\ ( \begin{matrix}x \\ y \\ z\end{matrix} ) = ( \begin{matrix}t \times cos θ \\ h \\ t \times sin θ\end{matrix} ) + \frac{z}{f} {( \begin{matrix}cos θ \\ 1 \\ sin θ\end{matrix} )}^{T} ( \begin{matrix}u - {u}_{0} \\ v - {v}_{0} \\ f\end{matrix} ) & ( 3 )\end{matrix}$$

Note that in Equation (3), T indicates a transpose.

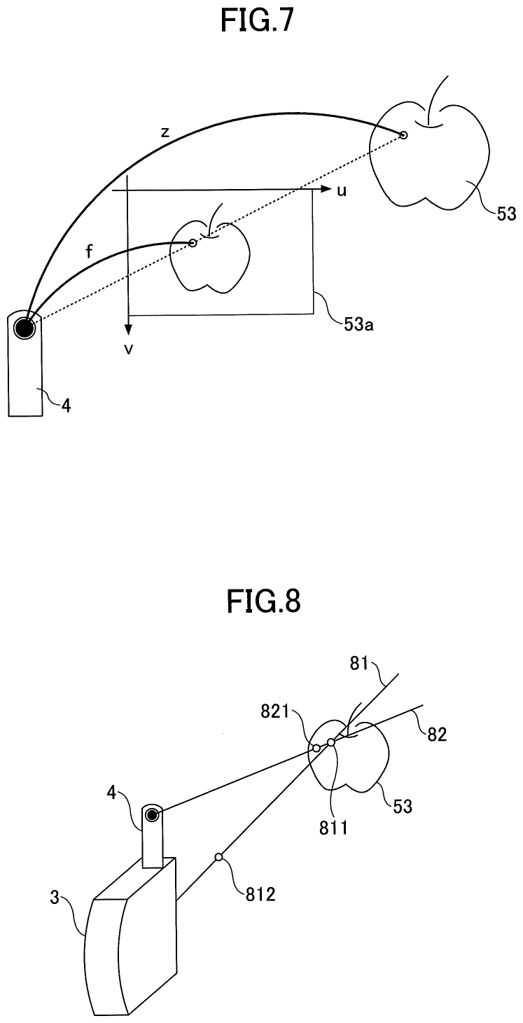

FIG. 8 is a diagram for explaining an example of processing performed by the three-dimensional position comparator.

A first three-dimensional position detected by the LIDAR unit 3 may result in detection of an erroneous distance due to shot noise caused by sunlight, or the like. In other words, a precise distance can be detected, but in some cases an erroneous distance may be detected.

In light of the issue, the three-dimensional position comparator 115 compares first three-dimensional position information with second three-dimensional position information associated with a mapped coordinate space. The three-dimensional position comparator 115 further selects first three-dimensional position information about which a detected value of a distance that is short from second three-dimensional position information is indicated, as three-dimensional position information that is estimated to be accurate.

In FIG. 8, with respect to first three-dimensional position information 811, a detected value of a distance that is short from second three-dimensional position information 821 is indicated. On the other hand, with respect to first three-dimensional position information 812, there is no detected value of a distance that is short from second three-dimensional position information.

In this case, the three-dimensional position comparator 115 selects only the first three-dimensional position information 811 as three-dimensional position information that is estimated to be accurate. In determining whether there is a detected value of a short distance, for example, a predetermined threshold can be used to determine that there is a detected value of a short distance, when a difference in the detected value of distance between first three-dimensional position information and second three-dimensional position information is smaller than the threshold.

### Operation of Three-Dimensional Position Detecting Device

Hereafter, the operation of the three-dimensional position detecting device 1 will be described according to the present embodiment.

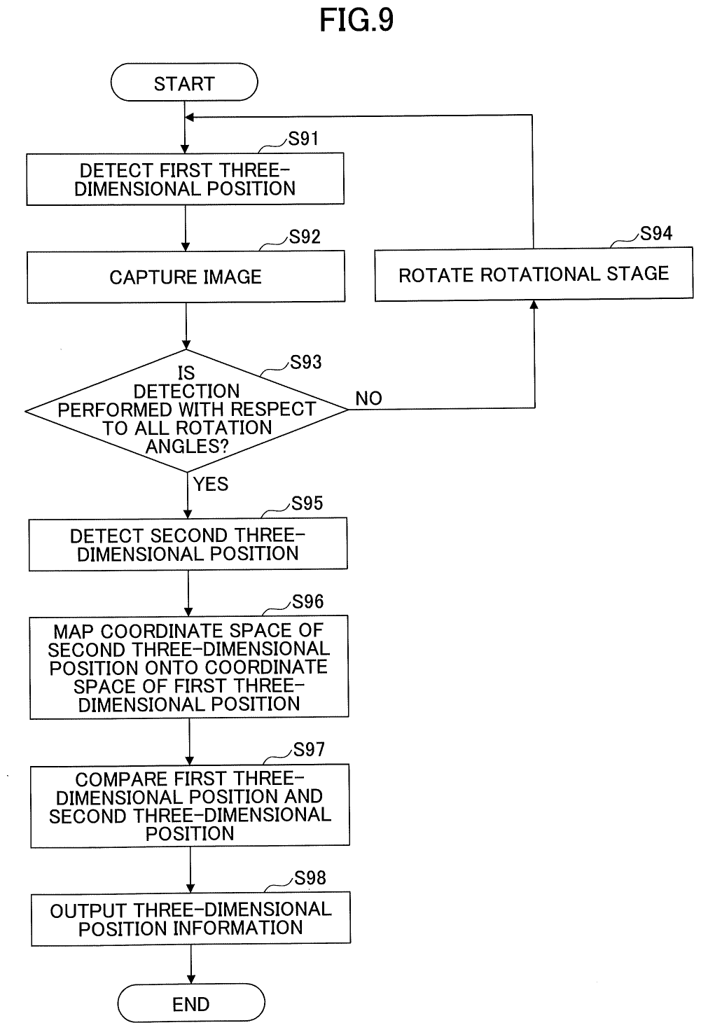

FIG. 9 is a flowchart illustrating an example of the operation of the three-dimensional position detecting device according to the present embodiment.

First, in step S91, the LIDAR unit 3 detects a first three-dimensional position in response to a predetermined rotation angle (such as the origin for rotation) at which the rotational stage 2 rotates. Information of the detected first three-dimensional position is outputted to the RAM 103, or the like, and is stored by the RAM 103, or the like.

Subsequently, in step S92, the 360-degree camera 4 captures an image in which an object is included. Information of the captured image is outputted to the RAM 103, or the like, and is stored by the RAM 103, or the like.

Subsequently, in step S93, the rotation controller 111 determines whether first three-dimensional positions are detected and images are captured for all predetermined rotation angles at which the rotational stage 2 rotates.

In step S93, when it is determined that first three-dimensional positions are not detected and images are not captured for all rotation angles (No in step S93), in step S94, the rotation controller 111 rotates the rotational stage 2 at a subsequently predetermined rotation angle. The process then returns to step S91.

On the other hand, in step S93, when it is determined that first three-dimensional positions are detected and images are captured for all rotation angles (Yes in step S93), in step S95, the stereo detector 113 performs stereo matching using two or more images that are captured in accordance with respective rotation angles at which the rotational stage 2 rotates, and then detects a second three-dimensional position. Information of the detected second three-dimensional position is outputted to the RAM 103 or the like, and is stored by the RAM 103 or the like.

Note that in this case, the stereo detector 113 may perform stereo matching as long as there are two or more pieces of first three-dimensional position information detected by the LIDAR unit 3, the two or more pieces of first three-dimensional position information being in accordance with the rotational stage 2 that rotates at respective predetermined rotation angles.

Second three-dimensional position information is used to select three-dimensional position information that is estimated to be accurate, from first three-dimensional position information. However, when the number of pieces of first three-dimensional position information is only one with respect to a given rotation angle, first three-dimensional position information is more likely to be accurate. In this case, stereo matching is skipped, and thus it is possible to reduce an arithmetic processing load as well as reduced processing time.

Referring back to FIG. 9, in step S96, the coordinate-space mapping unit 114 retrieves first three-dimensional position information and second three-dimensional position information, from the RAM 103 or the like. The coordinate-space mapping unit 114 then maps a coordinate space of the second three-dimensional position information onto a coordinate space of the first three-dimensional position information. In the present embodiment, because a first three-dimensional position and a second three-dimensional position are detected for each predetermined rotation angle at which the rotational stage 2 rotates, the coordinate-space mapping unit 114 performs mapping between the coordinate spaces, with respect to each predetermined rotation angle. The coordinate-space mapping unit 114 then outputs a mapped result to the three-dimensional position comparator 115.

Subsequently, in step S97, the three-dimensional position comparator 115 compares received first three-dimensional position information and second three-dimensional position information to select first three-dimensional position information that is estimated to be accurate. In this case, with respect to each predetermined rotation angle at which the rotational stage 2 rotates, as described in step S97, the three-dimensional position comparator 115 compares three-dimensional positions. As a result, the three-dimensional position comparator 115 outputs a compared result to the three-dimensional position output unit 116.

Subsequently, in step S98, the three-dimensional position output unit 116 receives the three-dimensional position information that is estimated to be accurate, through the three-dimensional position comparator 115. The three-dimensional position output unit 116 then outputs the three-dimensional position information to an external device such as a display device, or a PC (Personal Computer).

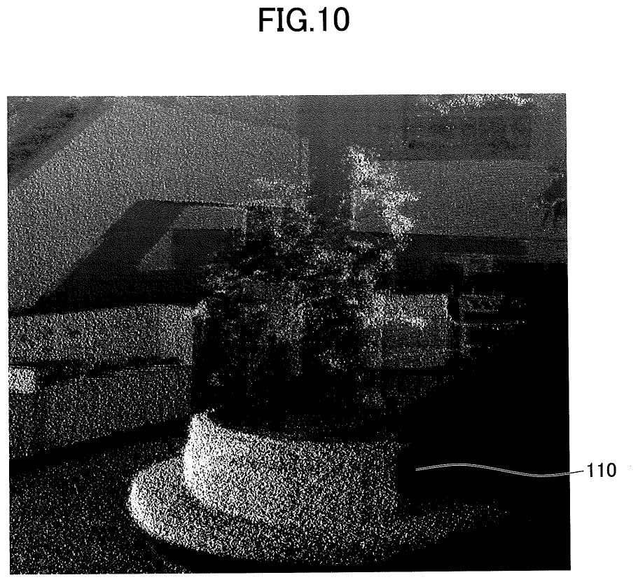

As described above, the three-dimensional position detecting device 1 can obtain three-dimensional position information to output the three-dimensional position information. FIG. 10 is a diagram illustrating an example of a detected result obtained by the three-dimensional position detecting device 1. In FIG. 10, a range image indicates a brightness value for each pixel, where a distance to a given object is converted into a given brightness value. In such a manner, a given three-dimensional position can be detected.

### Advantages of Three-Dimensional Position Detecting Device

As described above, in the present embodiment, three-dimensional position information that is estimated to be accurate is detected based on first three-dimensional position information and second three-dimensional position information that are detected in response to the rotational stage 2 rotating. In such a manner, the first three-dimensional position information is compared with the second three-dimensional position information to allow incorrect three-dimensional position information caused by shot noise to be removed from the first three-dimensional position information. As a result, a precise three-dimensional position of a given object can be detected.

Further, in the present embodiment, in order to reduce the error in a given detection through the LIDAR unit 3, multiple detections are avoided, or a post-processing of a detected value is avoided. Further, an additional function is not included. Thereby, the cost of the three-dimensional position detecting device 1 can be reduced.

### Second Embodiment

Hereafter, a three-dimensional position detecting system will be described according to a second embodiment. Note that explanation will be omitted for elements that are identical or sufficiently similar to elements that have been described in the first embodiment.

In FIG. 10, an example of the detected result of a given three-dimensional position has been indicated. However, as illustrated in a portion 110 in FIG. 10, light emitted by the LIDAR unit 3 may not reach the backside of a given object when viewed from a side of the three-dimensional position detecting device 1. Also, a given object may not be imaged even by the 360-degree camera 4. In such a manner, the backside of the object may create a blind spot, and thus a given three-dimensional position may not be detected.

In the three-dimensional position detecting system according to the present embodiment, a three-dimensional position detecting device 1 performs multiple detections while the three-dimensional position detecting system causes a change of a location of the three-dimensional position detecting device 1. Further, the three-dimensional position detecting system combines detected results to allow detection in a three-dimensional position, without creating a blind spot.

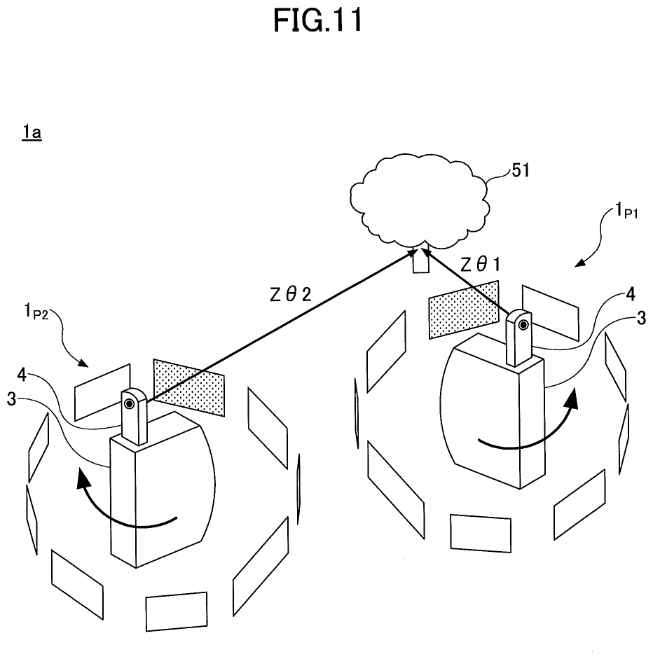

FIG. 11 is a diagram for explaining an example of a detection method by the three-dimensional position detecting system according to the present embodiment. As illustrated in FIG. 11, a three-dimensional position detecting device 1_{P1} indicates a three-dimensional position detecting device 1 that is disposed in a first location. A three-dimensional position detecting device 1_{P2} indicates a three-dimensional position detecting device 1 that is disposed in a second location different from the first location. Note that movement from the first location to the second location of the three-dimensional position detecting device 1 is achieved by a linear motion stage, which is not illustrated in FIG. 11.

With respect to the three-dimensional position detecting system 1a according to the present embodiment, the three-dimensional position detecting device 1 can perform multiple detections while changing locations, as described above.

### Configuration of Three-Dimensional Position Detecting System

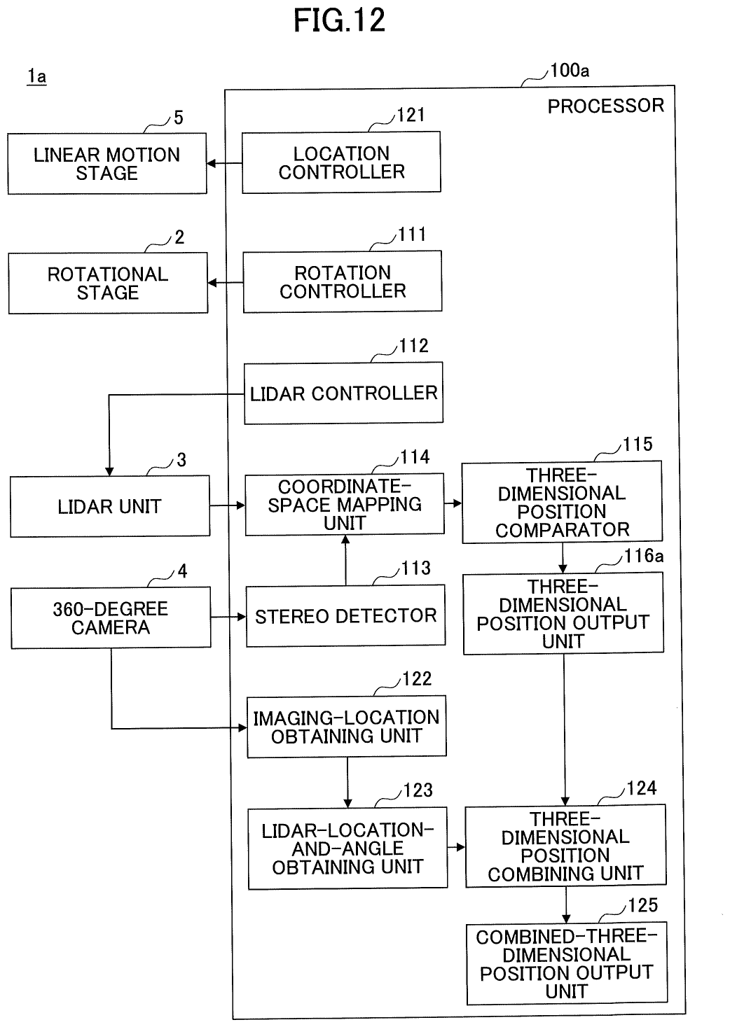

FIG. 12 is a block diagram for explaining an example of a functional configuration of the three-dimensional position detecting system according to the present embodiment.

As illustrated in FIG. 12, the three-dimensional position detecting system 1a includes a linear motion stage 5 and a processor 100a. The processor 100a includes a three-dimensional position output unit 116a, a location controller 121, an imaging-location obtaining unit 122, a LIDAR-location-and-angle obtaining unit 123, a three-dimensional position combining unit 124, and a combined-three-dimensional position output unit 125.

The three-dimensional position output unit 116a outputs three-dimensional position information with respect to each rotation angle, to a RAM 103 or the like, where the three-dimensional position information is received from a three-dimensional position comparator 115. The three-dimensional position output unit 116a can cause the RAM 103 or the like to store the three-dimensional position information with respect to each rotation angle.

The linear motion stage 5 is an example of a location changing unit. With the linear motion stage 5 moving a table on which the three-dimensional position detecting device 1 is disposed, the linear motion stage 5 can cause a change of a location of the three-dimensional position detecting device 1. Note that the number of axes that corresponds to respective directions in which the linear motion stage 5 moves may be suitably selected among one axis, two axes, and the like.

The location controller 121 is electrically connected to the linear motion stage 5. The location controller 121 controls a location of the three-dimensional position detecting device 1 through the linear motion stage 5. The location controller 121 can include an electric circuit or the like that outputs a drive voltage to the linear motion stage 5 in response to a control signal.

The imaging-location obtaining unit 122 obtains location information of the 360-degree camera 4 by an SFM method, based on images each of which the 360-degree camera 4 captures in response to a given location of the three-dimensional position detecting device 1 being changed by the linear motion stage 5. The imaging-location obtaining unit 122 outputs the obtained location information to the LIDAR-location-and-angle obtaining unit 123.

As described above, the SFM method is an image processing algorithm for estimating respective locations at which a camera is disposed, as well as three-dimensional spaces, from multiple images through the camera. An arithmetic device in which an algorithm for the SFM method is implemented searches for a feature point of each image to perform mapping with respect to similarity of feature points and a positional relationship between images. Also, the arithmetic device estimates a location where a given feature point is matched most appropriately, and can determine respective relative positions of the camera. Further, the arithmetic device can determine a three-dimensional position of a given feature point based on the respective positional relationships of the camera. Note that the SFM method can be taken as a known technique; accordingly, the detailed explanation for the SFM method will be not provided.

The LIDAR-location-and-angle obtaining unit 123 obtains information of a location and an angle (which may be hereafter referred to as location-and-angle information) of the LIDAR unit 3 based on received location information of the 360-degree camera 4, and outputs location-and-angle information to the three-dimensional position combining unit 124. The angle of location-and-angle information corresponds to a given rotational angle at which the rotational state 2 is rotated.

More particularly, firstly, the LIDAR-location-and-angle obtaining unit 123 identifies a position of the three-dimensional position detecting device 1 (a point of the center of a plane represented as the three-dimensional position detecting device 1) based on location information of the 360-degree camera 4. Further, location information of the LIDAR unit 3 relative to the identified center point of the three-dimensional position detecting device 1 can be used to obtain location-and-angle information of the LIDAR unit 3.

The three-dimensional position combining unit 124 combines three-dimensional positions that are detected, based on the location-and-angle information of the LIDAR unit 3, by the three-dimensional position detecting device 1 and that are stored by the RAM 103 or the like. The three-dimensional position combining unit 124 outputs a combined result to the combined-three-dimensional position output unit 125.

The combined-three-dimensional position output unit 125 can output a received three-dimensional position (combined result) to an external device such as a display device or a PC.

### Operation of Three-Dimensional Position Detecting System

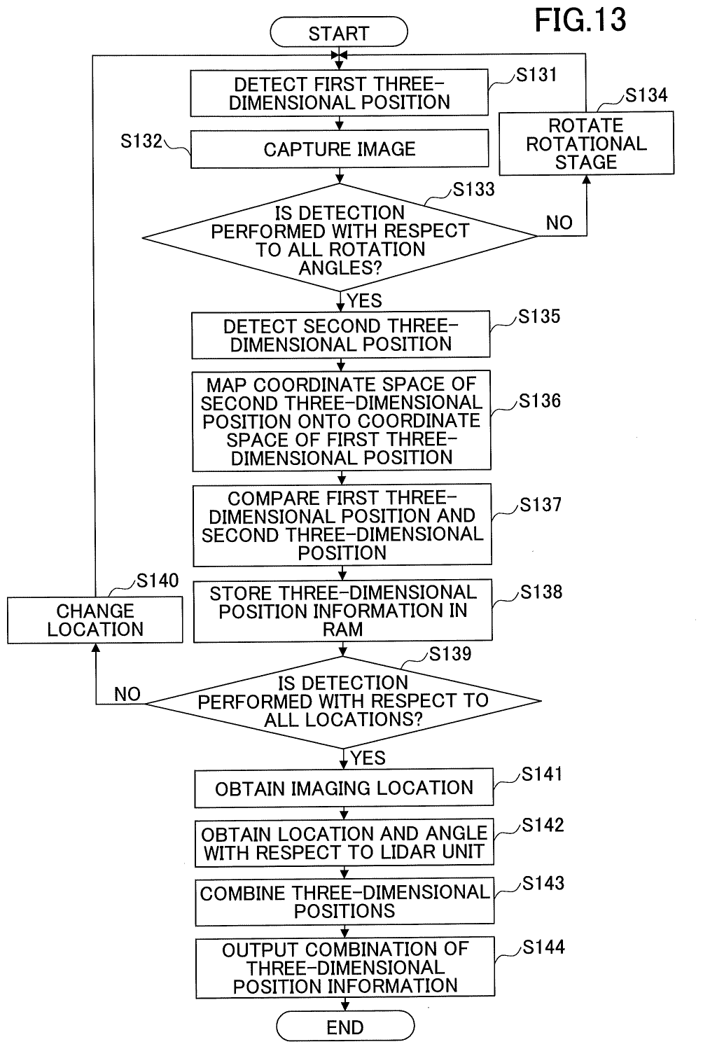

FIG. 13 is a flowchart illustrating an example of an operation of the three-dimensional position detecting system according to the present embodiment.

A process of steps S131 through S137 in FIG. 13 is similar to the process of steps S91 through S97 in FIG. 9; accordingly, the explanation will be omitted for steps S131 through S137.

In step S138, the three-dimensional position output unit 116a outputs, with respect to each rotation angle, three-dimensional position information received from the three-dimensional position comparator 115, to the RAM 103a or the like. The outputted three-dimensional position information is stored by the RAM 103a or the like.

Subsequently, in step S139, the location controller 121 determines whether detection is performed by the three-dimensional position detecting device 1 that is disposed in all determined locations.

In step S139, when it is determined that detection is not performed by the three-dimensional position detecting device 1 that is disposed in all determined locations (No in step S139), in step S140, the location controller 121 moves the linear motion stage 5 by a predetermined amount of movement to change a location of the three-dimensional position detecting device 1. The process then returns to step S131.

On the other hand, in step S139, when it is determined that detection is performed by the three-dimensional position detecting device 1 that is disposed in all determined locations (YES in step S139), in step S141, the imaging-location obtaining unit 122 obtains location information of the 360-degree camera 4 by the SFM method, based on images each of which the 360-degree camera 4 captures in accordance with a given location of the three-dimensional position detecting device 1 being changed by the linear motion stage 5, where the images are stored by the RAM 103 or the like. Further, the imaging-location obtaining unit 122 outputs the obtained position information of the 360-degree camera 4 to the LIDAR-location-and-angle obtaining unit 123.

Subsequently, in step S142, the LIDAR-location-and-angle obtaining unit 123 obtains location-and-angle information of the LIDAR unit 3 based on a positional relationship between the rotation axis and received location information of the input 360-degree camera 4. Further, the LIDAR-location-and-angle obtaining unit 123 outputs the obtained location-and-angle information to the three-dimensional position combining unit 124.

Subsequently, in step S143, the three-dimensional position combining unit 124 retrieves three-dimensional position information with respect to each location, from the RAM 103 or the like. Further, the three-dimensional position combining unit 124 combines retrieved pieces of three-dimensional position information based on the location-and-angle information of the LIDAR unit 3. The three-dimensional position combining unit 124 then outputs a combination of three-dimensional position information to the combined-three-dimensional position output unit 125.

Subsequently, in step S144, the combined-three-dimensional position output unit 125 outputs a received combination of three-dimensional position information to an external device such as a display device or a PC.

As described above, the three-dimensional position detecting system 1a combines multiple pieces of three-dimensional position information with respect to respective changed locations to obtain a combination of three-dimensional position information. The three-dimensional position detecting system 1a can further output such a combination of three-dimensional position information.

### Advantages of Three-Dimensional Position Detecting System

As described above, in the present embodiment, a combination of three-dimensional position information is detected based on one or more pieces of three-dimensional position information, each of which the three-dimensional position detecting device 1 detects in accordance with a given changed location of the three-dimensional position detecting device 1 through the linear motion stage 5. Thereby, the detection in a three-dimensional position of a given object that does not create a blind spot can be accurately performed.

For example, a comparative example for combining three-dimensional positions detected in different locations includes: a manner in which three-dimensional positions are meshed; subsequently, meshed positions are compared to find a close point to a given position in a structure to combine positions for the close points; or a manner in which displacement from a given point of detecting a three-dimensional position through an acceleration sensor or the like is determined to decrease the displacement, etc.

With respect to the above manner of meshing, when a data interval of three-dimensional positions is decreased (high resolution), three-dimensional positions may not be easily meshed. Alternatively, when a space such as an indoor space is increased, three-dimensional positions may not be easily meshed. Also, with respect to the above manner of using an acceleration sensor or the like, the acceleration sensor or the like is further included in a three-dimensional position detecting system, which may result in a complex system configuration with increased costs.

In the present embodiment, pieces of three-dimensional position information are combined based on images captured by the 360-degree camera 4, thereby obtaining a combination of three-dimensional position information with high accuracy, simplicity, and reduced costs.

Other advantages are similar to the advantages described in the first embodiment.

Note that the present disclosure is not limited to the specific embodiments described above, and various changes and modifications can be made within the scope of the disclosure.

The present embodiment also includes a method for detecting three-dimensional positions. For example, the method for detecting three-dimensional positions includes: rotating a rotational mechanism about a predetermined rotation axis; scanning, by a LIDAR (Light Detection And Ranging) unit disposed on the rotation axis, in accordance with each rotation angle at which the rotational mechanism rotates to detect at least one first three-dimensional position of an object; capturing, by an imaging unit disposed to be away from the rotation axis in a direction perpendicular to the rotation axis, multiple images of the object based on rotation of the imaging unit through the rotational mechanism; detecting a second three-dimensional position of the object based on the captured multiple images with respect to respective rotation angles at which the rotational mechanism rotates; and obtaining a three-dimensional position of the object based on a comparison of the first three-dimensional position and the second three-dimensional position; and outputting the three-dimensional position. Such a method has a similar effect to the effect described in the three-dimensional position detecting device.

Each function of the embodiments described above can also be implemented by one or more processing circuits. A “processing circuit” used in the specification includes: a processor programmed to perform each function by software, such as a processor implemented in an electronic circuit; an ASIC (Application Specific Integrated Circuit) designed to perform each function as described above; a digital signal processor (DSP); a field programmable gate array (FPGA); or a device such as a known circuit module.

What is claimed is:

1. A three-dimensional position detecting device comprising:
a rotational mechanism configured to rotate about a predetermined rotation axis;
a LIDAR (Light Detection And Ranging) unit disposed on the rotation axis, the LIDAR unit being configured to scan in accordance with each rotation angle at which the rotational mechanism rotates to detect at least one first three-dimensional position of an object;
an imaging unit disposed to be away from the rotation axis in a direction perpendicular to the rotation axis, the imaging unit being configured to capture multiple images of the object based on rotation of the imaging unit through the rotational mechanism;
a memory; and
a processor electrically coupled to the memory, the processor being configured to:
detect a second three-dimensional position of the object based on the captured multiple images with respect to respective rotation angles at which the rotational mechanism rotates; and
obtain a three-dimensional position of the object based on a comparison of the first three-dimensional position and the second three-dimensional position; and
output the three-dimensional position.

2. The three-dimensional position detecting device according to claim 1, wherein the LIDAR unit includes a light scanning unit configured to scan with light with respect to two axial directions that are mutually perpendicular.

3. The three-dimensional position detecting device according to claim 1, wherein the processor is configured to detect the second three-dimensional position based on a disparity between the multiple images.

4. The three-dimensional position detecting device according to claim 1, wherein the imaging unit includes a 360-degree camera configured to capture a 360-degree image.

5. The three-dimensional position detecting device according to claim 3, wherein the at least one first three-dimensional position is multiple first three-dimensional positions with respect to respective rotation angles at which the rotational mechanism rotates.

6. A three-dimensional position detecting system comprising:
the three-dimensional position detecting device according to claim 1; and
a location changing unit on which the three-dimensional position detecting device is disposed, the location changing unit being configured to change a location at which the three-dimensional position detecting device is disposed, the processor of the three-dimensional position detecting device being configured to:
use structure from motion (SFM) to estimate a location of the imaging unit based on respective images that the imaging unit captures in accordance with locations of the three-dimensional position detecting device changed through the location changing unit;
estimate a location of the LIDAR unit and an angle at which the LIDAR unit is rotated based on a positional relationship between the rotation axis and the imaging unit, the angle corresponding to a given rotational angle at which the rotational mechanism is rotated;
combine three-dimensional positions based on the location of the LIDAR unit and the angle at which the LIDAR unit is rotated, each of the three-dimensional positions being obtained based on a comparison of a given first three-dimensional position and a given second three-dimensional position; and
output a three-dimensional position combination.

7. A method for detecting three-dimensional positions comprising:
rotating a rotational mechanism about a predetermined rotation axis;
scanning, by a LIDAR (Light Detection And Ranging) unit disposed on the rotation axis, in accordance with each rotation angle at which the rotational mechanism rotates to detect at least one first three-dimensional position of an object;
capturing, by an imaging unit disposed to be away from the rotation axis in a direction perpendicular to the rotation axis, multiple images of the object based on rotation of the imaging unit through the rotational mechanism;
detecting a second three-dimensional position of the object based on the captured multiple images with respect to respective rotation angles at which the rotational mechanism rotates; and
obtaining a three-dimensional position of the object based on a comparison of the first three-dimensional position and the second three-dimensional position; and
outputting the three-dimensional position.
